(19) United States
(12) Patent Application Publication
(10) Pub. No.: US 2009/0101772 A1
(43) Pub. Date: Apr. 23, 2009

(54) Level indicator clip for tripods and other structures

(76) Inventor: JoeBen Bevirt, Santa Cruz, CA (US)

Correspondence Address: MICHAEL A. GUTH, 2-2905 EAST CLIFF DRIVE, SANTA CRUZ, CA, 95062, US

(21) Appl. No.: 12/152,273

(22) Filed: May 12, 2008

Related U.S. Application Data
(63) Continuation-in-part of application No. 11/324,994, filed on Jan. 3, 2006.

(51) Int. Cl. F16M 11/02; G01C 5/00

(52) U.S. Cl. 248/180.1; 33/290

(57) ABSTRACT

The present invention is directed to a mounting clips and structures to support the mounting clips. The mounting clips may use a bubble level or other device to allow the user to level the item supported, such as a camera. The mounting clips may be used with a tripod or a monopod, and in some embodiments a tripod with flexible legs utilizing ball and socket joint connectors which, when interconnected, form a flexible assembly. The use of flexible mounting apparatus allows the user to mount an item such as a camera in a variety of locations, but this in turn may make it difficult for the user to level the view from the camera. A clip with a level device within it allows for such leveling.

### BACKGROUND

1. Field of the Invention

This invention relates a clip for support structures, such as a tripod, with an indicator of the level of the clip.

2. Description of Related Art

Mounting devices may come in a variety of forms. Some mounting devices are used to mount various types of hardware to a variety of types of structure. Tripod structures may be used to mount devices.

Typical tripod assemblies consist of three rigid legs which are splayed out to form a support structure for devices such as cameras. The legs are usually rigid and adapted to provide support off of the ground or other flat surface. Some tripods have some adjustment to leg length which may allow for some deviation from flatness in the surface upon which they are mounted. Such tripods are limited in the manner in which they support devices. In addition, new mounting clips are needed to meet the need for mounting a variety of devices.

What is called for is a mounting apparatus that may function as a tripod and also as a grip mount for the mounting to vertical members. What is also called for is a clip that has a device within it to determine whether the item mounted to the mounting apparatus is level. What is also called for are accessory clips for mounting of different items to tripods and monopods.

### SUMMARY

The present invention is directed to a mounting clips and structures to support the mounting clips. The mounting clips may use a bubble level or other device to allow the user to level the item supported, such as a camera.

The mounting clips may be used with a tripod or a monopod, and in some embodiments a tripod with flexible legs utilizing ball and socket joint connectors which, when interconnected, form a flexible assembly. The use of flexible mounting apparatus allows the user to mount an item such as a camera in a variety of locations, but this in turn may make it difficult for the user to level the view from the camera. A clip with a level device within it allows for such leveling.

### BRIEF DESCRIPTION OF THE DRAWINGS

FIG. 1 is a perspective view of a tripod with a level clip according to some embodiments of the present invention.

FIG. 2 is an end view of the upper end of a tripod and clip with a cross-sectional view along the insertion axis of the clip according to some embodiments of the present invention.

FIG. 3 is a side view of the upper end of a tripod and clip with a cross-sectional view perpendicular to the insertion axis of the clip according to some embodiments of the present invention.

FIG. 4 is a raised perspective view of a level clip according to some embodiments of the present invention.

FIG. 5 is a side view of a level clip according to some embodiments of the present invention.

FIG. 6 is a rear view of a level clip according to some embodiments of the present invention.

FIG. 7 is a front view of a level clip according to some embodiments of the present invention.

FIG. 8 is a top and cross-sectional view of a level clip according to some embodiments of the present invention.

FIG. 9 is a bottom view of a level clip according to some embodiments of the present invention.

FIGS. 10A-G are views of a two axis level clip according to some embodiments of the present invention.

FIG. 11 is a sketch of a monopod mounting apparatus according to some embodiments of the present invention.

### DETAILED DESCRIPTION

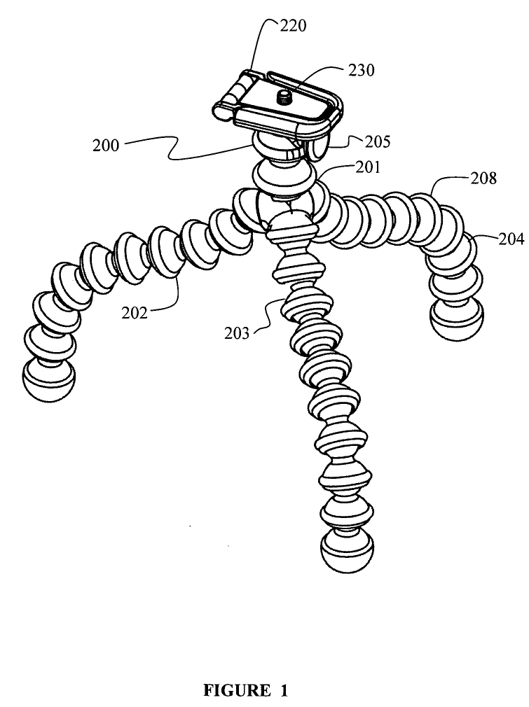

FIG. 1 illustrates a tripod apparatus 200 according to some embodiments of the present invention. A body portion 201 provides a base of support for three flexible legs 202, 203, 204. The flexible legs 202, 203, 204 consist of a series of interconnected ball and socket joint connectors. The flexible legs are able to be flexed into a variety of positions and can be used to support the body portion 201 by forming tripod support. The flexible legs are able to adapt to uneven surfaces to allow the tripod to function in a variety of situations. Although three legs are used here for illustration, more legs may be present in some embodiments. As seen, the body portion 201 itself may have a series of interconnected ball and socket joint connectors within it, allowing for even more flexibility with regard to its mounting function.

Although the flexible legs are illustrated as functioning legs, the legs are of sufficient flexibility that the may be used to wrap around items such as bars or other objects in order to fasten the tripod apparatus to objects that would not be suitable for mounting of a typical tripod. In conjunction with the gripping portion, this allows the tripod apparatus to be fastened to a variety of objects. For example, when used to position a digital camera, the legs may wrap around a vertical gate rail, allowing the mounting of the camera for a photo taking opportunity not previously available.

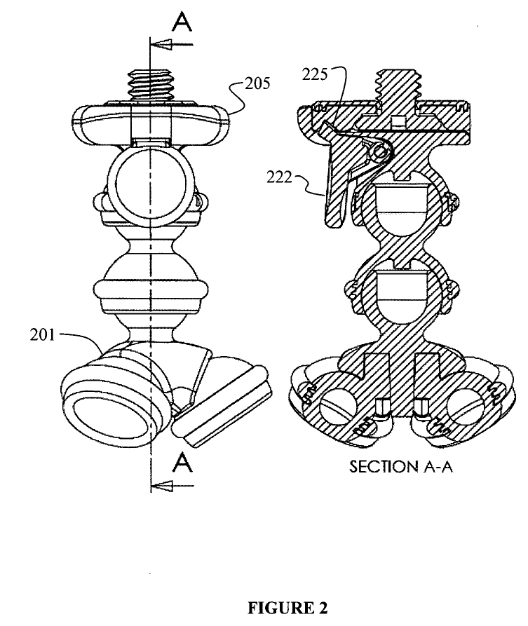

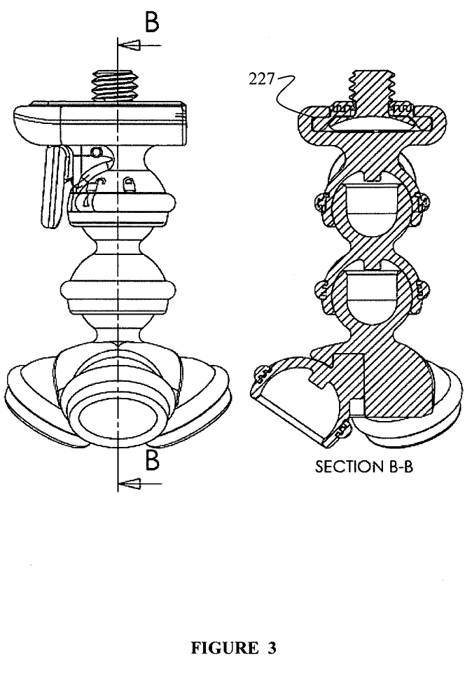

FIGS. 2 and 3 illustrate the upper end of the tripod in cross-section. In some embodiments, the body portion 201 is connected to an interconnect portion 205. A level clip 220 is removably fastened to the interconnect portion 205. The level clip 220 may have a threaded post 230 adapted to fit into a camera or other device in some embodiments.

In some embodiments, the flexible legs 202, 203, 204 may use connectors that have a co-molded gripping portion 208. The gripping portions 208 may allow for use of the tripod in a variety of ways, including wrapping of the legs around a post or other object. In some embodiments, the flexible legs may be terminated with a gripping pod 207. The gripping pod 207 may be fully molded into the cavity of the connector. In some embodiments, the terminal connector of each leg has a socket engaging end surface on its first end and a suction cup on its second end. The suctions cups may allow for a secure attachment of the tripod apparatus 200 to a variety of surfaces.

Although the level clip has been illustrated in an embodiment with a tripod with flexible legs, the level clip may be used with a standard tripod, or other types of support structures, in other embodiments.

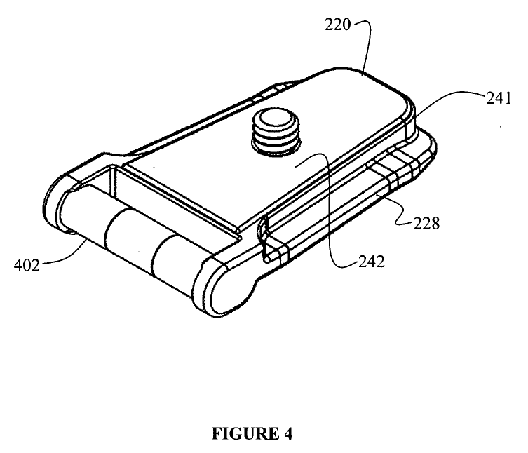

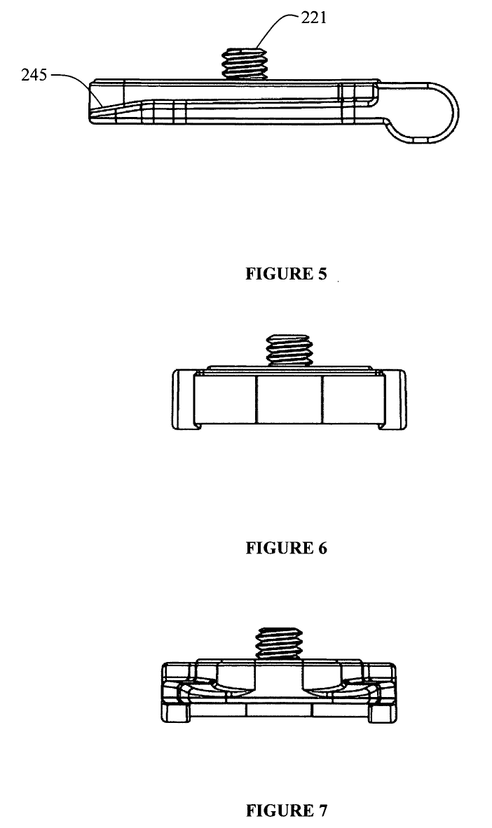

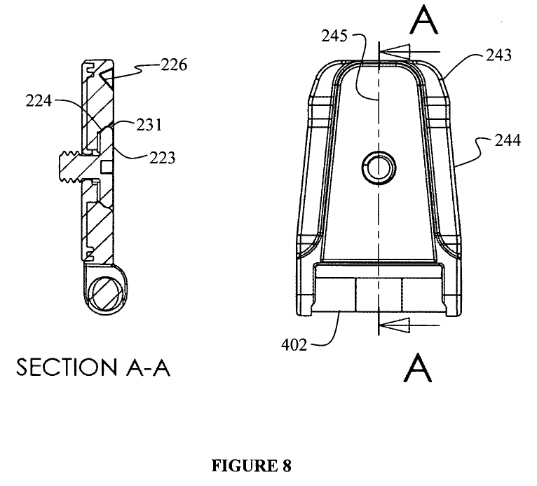

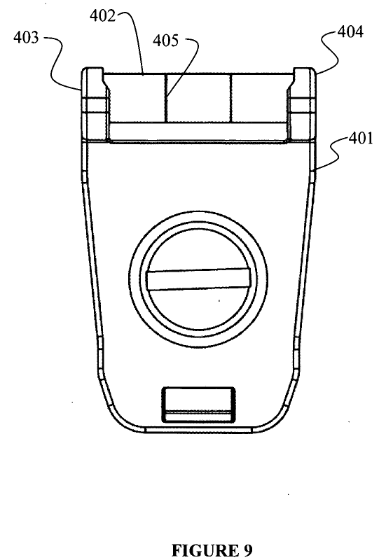

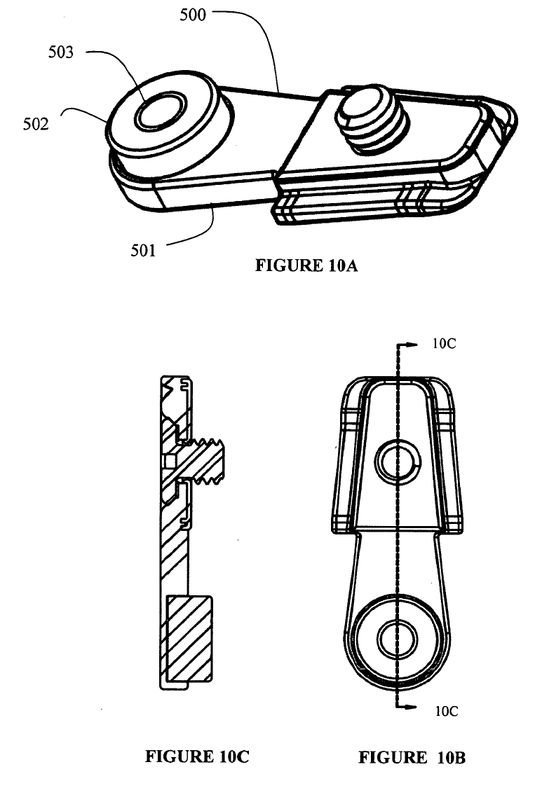

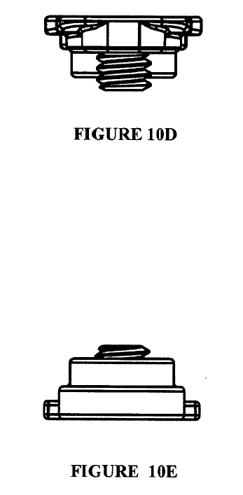

FIGS. 4-9 illustrate a level clip 220 according to some embodiments of the present invention. In some embodiments of the present invention, the interconnect portion 205 is adapted to receive a level clip 220. The level clip 220 may have rails 228 adapted to slide into slots 227 within the interconnect portion 205. The clip 220 may have recess 226 adapted to be filled by a tab 225 on a spring loaded lever 222. The clip is removably attached to the interconnect portion 205 and may be released by pressing on the lever 222. In some embodiments, the lever 222 is on the same side of the interconnect portion 205 as which the clip 220 slides in on. In other embodiments, the lever 222 is on the side opposite that which the clip 220 slides in on.

The level clip 220 may have a flat plate body 241 in some embodiments. A grip pad 242 may reside on the top of the plate to allow for secure mounting of a device, such as a camera. A mounting screw 221 may be recess mounted into the clip 220 in some embodiments. The screw 221 may be of the standard size and thread to attach to a camera in some embodiments. The head 223 of the screw 221 may be held into the recess 224 by a slight ridge 231 in the molding of the recess in some embodiments. A recess 226 is seen in the bottom of the planar plate of the clip. The recess 226 is adapted to allow for the capture of the clip by a tab when slid into an interfacing portion of a support structure, such as may be used with a tripod. A neckdown 245 on the rail allows for easier insertion of the clip into its interfacing connector in the direction perpendicular to the plate. Two neckdown portions 243, 244 allow both for easier insertion and also a much more stable and secure fit once the clip is in place.

The removable aspect of the clip allows the support structure to be used with different types of clips when desired by the user. In addition, the user may want to attach the clip to the device and remove the device with the clip attached from the support structure.

In some embodiments, the level indicator 402 is a single axis level indicator and is adapted to indicate level relative to the plane of the flat plate of the clip. In some embodiments, the level indicator is placed to read perpendicular to the insertion axis 245 of the level clip 220. The level indicator 402 may be a cylindrical tube full of liquid with a bubble within it. The cylindrical tube may be held with brackets 403, 404 to the flat body plate of the level clip. There may be marking lines 405 on the tube to help indicate when the level clip is level.

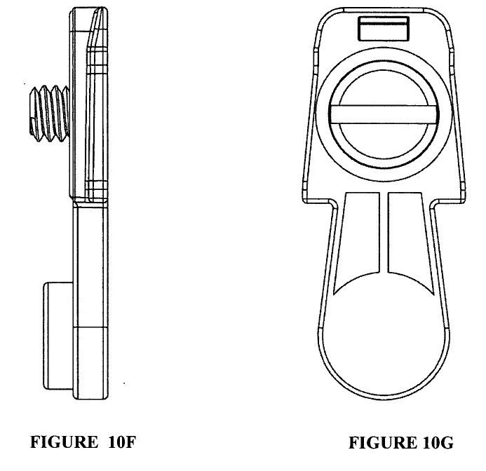

In some embodiments of the present invention, as seen in FIGS. 10A-G, a two-axis level clip is used. The clip body 500 has a level device 501 adapted to indicate level in two axis. In some embodiments, the two axis which are measured are within the plane of the flat plate of the clip. A circular liquid filled capsule 502 with an air bubble 503 may be used in some embodiments.

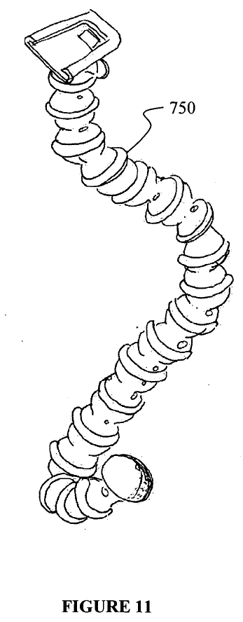

FIG. 11 illustrates a monopod, or unipod, with removably attached clips according to some embodiments of the present invention. A monopod 750 is seen with a series of ball and socket connectors with an overmolded grip strip as seen in other embodiments of the present invention. The monopod 750 may have an interface portion which is adapted to receive clips according to embodiments of the present invention. The monopod 750 allows for mounting to members, such as a vertical member 752. An electronic item, camera, or other item, may be attached to a mounting clip with a level indicator and supported by the support structure.

As evident from the above description, a wide variety of embodiments may be configured from the description given herein and additional advantages and modifications will readily occur to those skilled in the art. The invention in its broader aspects is, therefore, not limited to the specific details and illustrative examples shown and described. Accordingly, departures from such details may be made without departing from the spirit or scope of the applicant's general invention.

I claim:

1. A level clip, said level clip comprising:
a clip body, said clip body comprising a flat plate; and
a level indicator.

2. The level clip of claim 1 wherein said flat plate has rails along its sides.

3. The level clip of claim 2 wherein said clip comprises a threaded fastener.

4. The level clip of claim 3 wherein the threads of said threaded fastener protrude through the top of said clip body.

5. The level clip of claim 4 wherein said clip body comprises a hole in its bottom surface, wherein the head of said threaded fastener resides in said hole.

6. The level clip of claim 5 wherein said head of said fastener is restrained in said hole by a ridge portion in the bottom of said clip.

7. The level clip of claim 1 wherein said level indicator comprises a bubble level device.

8. The level clip of claim 4 wherein said level indicator comprises a bubble level device.

9. The level clip of claim 7 wherein said bubble level device is a single axis bubble level device.

10. The level clip of claim 8 wherein said bubble level device is a single axis bubble level device.

11. The level clip of claim 7 wherein said bubble level device is a two axis bubble level device.

12. The level clip of claim 8 wherein said bubble level device is a two axis bubble level device.

13. The level clip of claim 9 wherein said bubble level device is adapted to measure level in a plane parallel to said flat plate.

14. The level clip of claim 10 wherein said bubble level device is adapted to measure level in a plane parallel to said flat plate.

15. The level clip of claim 13 wherein said clip body is adapted to be inserted into a receiver along an insertion axis, and wherein said bubble level device is adapted to measure level in a plane perpendicular to said insertion axis.

16. The level clip of claim 14 wherein said clip body is adapted to be inserted into a receiver along an insertion axis, and wherein said bubble level device is adapted to measure level in a plane perpendicular to said insertion axis.

17. A tripod comprising:
three legs;
a body;
a clip support carried by the body, the clip support having a releasable latch, wherein the clip support is suitable for releasably receiving a clip member to facilitate attaching a camera to the tripod; and
a level clip, said level clip comprising a level indicator, said level clip adapted to clip into said clip support.

18. The tripod of claim 17 wherein said legs are flexible legs.

19. The tripod of claim 17 wherein said clip support further comprises a base, a floor carried by the base, and flanges that define slots that extend above the floor and apart towards a clip receiving opening, and wherein said releasable latch is pivotably secured to the base and includes a tab.

20. The tripod of claim 19 wherein said level indicator comprises a bubble level device.
